(19) United States
(12) Patent Application Publication
(10) Pub. No.: US 2024/0046007 A1
(43) Pub. Date: Feb. 8, 2024

(54) METHOD OF DESIGNING EVAPORATIVE COOLING OF ELECTRIC MOTOR

(71) Applicant: Georgia Tech Research Corporation, Atlanta, GA (US)

(72) Inventors: Amitav Tikadar, Atlanta, GA (US); Yogendra K. Joshi, Atlanta, GA (US); Satish Kumar, Atlanta, GA (US)

(21) Appl. No.: 18/204,294

(22) Filed: May 31, 2023

Related U.S. Application Data
(60) Provisional application No. 63/395,917, filed on Aug. 8, 2022.

(51) Int. Cl. G06F 30/20

(52) U.S. Cl. CPC G06F 30/20

(57) ABSTRACT

In a method of generating a design of a cooling system for an electric motor according to a cooling system specification, a design for an evaporative cooling jacket for the electric motor is generated. The design is modelled by executing the following steps employing a computer program stored on a digital computer including a non-transitory computer readable storage medium. An electromagnetic model of the design for simulating electromagnetic parameters in the electric motor and the cooling system is generated. A motor heat transfer model of the design for determining heat transfer in the electric motor is generated. An evaporative heat transfer model for simulating heat transfer in the cooling system due to evaporative cooling is generated. A contact resistance model of the design to determine contact resistance between a rotor lamination-magnet, a winding-slot liner, a slot liner-stator lamination, and a stator lamination-housing is generated. A thermophysical properties model of the design that incorporates equivalent axial thermal conductivity (kz), density (ρ), and specific heat (Cp) of lamination material employed in the design is generated. Results of the electromagnetic model, the motor heat transfer model, the evaporative heat transfer model, the contact resistance model and the thermophysical properties model are compared to the cooling system specification. The design of the cooling system is modified when the results differ from the specification.

### CROSS-REFERENCE TO RELATED APPLICATION(S)

This application claims the benefit of U.S. Provisional Patent Application Ser. No. 63/395,917, filed Aug. 8, 2022, the entirety of which is hereby incorporated herein by reference.

### STATEMENT OF GOVERNMENT SUPPORT

This invention was made with government support under grant number DE-AR0001023, awarded by the ARPA-E. The government has certain rights in the invention.

### BACKGROUND OF THE INVENTION

### 1. Field of the Invention

The present invention relates to electric motors and, more specifically, to a method of designing an evaporative cooling system for an electric motor.

### 2. Description of the Related Art

With transport electrification becoming more commonly used, along with the associated increase in demand for electric motors, different cooling techniques have been developed and applied. The most used cooling method is water jacket cooling. Other methods include, direct cooling of rotor, and spray cooling. However, these methods employ single phase cooling in which the coolant is separated by multiple thermal resistances from the primary heat source (copper windings in the stator). Effective cooling of the motor windings directly affects the performance and the efficiency of the motor.

Stringent greenhouse gas emission standards have accelerated the need for electrification of ground and air transportation. Since electric machines are one of the core components of the electric drivetrain, improvement of their performance is a key enabler of better performance metrics of electric drivetrains. These performance metrics include higher power and torque density, better fuel economy (and the associated lower cost per mile), and overall drivetrain efficiency. Permanent magnet synchronous motors (PMSM) are commonly used in traction powertrains because of their superior performance on these metrics. However, high heat generation in PMSMs as a consequence of electro-magnetic losses especially at high power density limits motor efficiency and longevity by ultimate aging of the winding wire insulation and premature demagnetization of the magnets. Therefore, enhanced cooling technology is important in increasing motor power and torque density by pushing up the current density, while keeping peak winding temperature below the winding insulation temperature threshold without compromising efficiency.

For low power density electric machines, typically air cooling is used, whereas indirect liquid cooling is used for high power density electric motors. Typically, in automotive and industrial machines, closed loop liquid cooling via an external cooling jacket is utilized. However, jacket cooling (JC) technology often suffers from poor heat extraction from the winding to the external coolant because of the multiple thermal resistances between the winding and the coolant.

The thermal resistance between the winding and the coolant can be reduced by placing the cooling channel directly in the stator lamination. However, cooling channels in stator lamination can alter the magnetic flux path by imposing extra reluctances. By realizing these limitations of the JC and direct stator cooling, one system employed a water cooled direct winding heat exchanger (DWHX) concept to extract heat directly from the winding. Water cooled DWHX reduces thermal resistances between the windings and the coolant, and hence higher current density can be achieved while operating within the insulation's thermal limit.

Recent improvements in 3D printing technology enable fabrication of complex DWHX geometry along with internal flow channels to further improve the efficacy of DWHX. However, DWHX reduces cooper fill factor by occupying slot area, which eventually results in high copper loss. Also, water cooled DWHX can be used only in concentrated wound machines.

Additionally, proper sealing needs to be ensured for safe operation of water cooled DWHX systems. Water can be replaced by an oil/dielectric coolant to minimize the water leakage risk, but only at the expense of poor thermal and hydraulic performance. One system replaced the centermost conductor bunch in a standard Litz wire bundle of a tooth-coil axial-flux permanent-magnet motor by axial stainless steel cooling channel. Although use of an axial cooling channel significantly reduces the machine temperature, the fabrication of a Litz wire bundle with axial cooling channel adds complexity to the system. One system uses an axial cooling channel in the bottom of the stator slot of a switched reluctance motor and also an applied enhanced polymer composite as potting material to reduce the thermal resistance between the winding and the cooling channel. However, potting material thermal resistance can be significant.

In conventional external jacket cooled motors, end-windings are commonly identified as motor hot-spots because of the limited heat dissipation through the air gap between the end-winding and the housing where cooling ducts are located. One system places a liquid-carrying plastic pipe in the end-windings to reduce the thermal resistance between the end-winding and the coolant. However, this end-winding cooling technique often suffers from increased end-winding length, resulting in increased copper loss and contact resistance between the end-winding and the coolant carrying pipe. One system applies thermally conductive potting material (3.5 W/mK) in the end-space to provide a direct conductive heat transfer path between the end-winding and the external cooling channel. However, the application of potting material in large size traction motors is challenging and the additional weight of the potting material results in a lower specific output power and torque.

A latent heat driven two-phase cooling technique employing a heat pipe has also been used for high power density electric motor thermal management. With such a technique, an evaporator section of the heat pipe is placed directly in the stator slot, while a condenser section is axially extended beyond the stator up to a cooling chamber/air heat exchanger. Lower copper fill factor and risk of heat pipe leakage are the major drawbacks of these cooling techniques. The evaporator section of the heat pipe can also be placed inside the rotor/shaft, but this concept suffers from high risk of heat pipe damage, especially at high rotational speed.

Oil spray cooling is another two-phase cooling technique used for the end-winding cooling. Although it has a high heat transfer coefficient, a uniform end-winding temperature can be achieved by employing spray cooling. However, a high pumping power requirement offsets the thermal benefits of the spray cooling.

Close placement of the cooling medium to the winding is available thermal management techniques. However, low copper fill factor, high losses, high winding-liner and liner-lamination contact resistances, high manufacturing complexity, and limited application in concentrated wound machines often outweigh the thermal benefits of single-phase DWHX.

Therefore, there is a need for a computationally efficient method of modeling an evaporative cooling system for an electric motor.

### SUMMARY OF THE INVENTION

The disadvantages of the prior art are overcome by the present invention which, in one aspect, is a method of generating a design of a cooling system for an electric motor according to a cooling system specification, in which a design for an evaporative cooling jacket for the electric motor is generated. The design is modelled by executing the following steps employing a computer program stored on a digital computer including a non-transitory computer readable storage medium. An electromagnetic model of the design for simulating electromagnetic parameters in the electric motor and the cooling system is generated. A motor heat transfer model of the design for determining heat transfer in the electric motor is generated. An evaporative heat transfer model for simulating heat transfer in the cooling system due to evaporative cooling is generated. A contact resistance model of the design to determine contact resistance between a rotor lamination-magnet, a winding-slot liner, a slot liner-stator lamination, and a stator lamination-housing is generated. A thermophysical properties model of the design that incorporates equivalent axial thermal conductivity (kz), density (ρ), and specific heat (Cp) of lamination material employed in the design is generated. Results of the electromagnetic model, the motor heat transfer model, the evaporative heat transfer model, the contact resistance model and the thermophysical properties model are compared to the cooling system specification. The design of the cooling system is modified when the results differ from the specification.

In another aspect, the invention is a method for analyzing and designing electric motors employing evaporative cooling (EC) for thermal management, in which fluid dynamics/heat transfer (CFD/HT) with a CFD/HT model is determined. A lumped parameter thermal network (LPTN) with an LPTN model is also determined.

In yet another aspect, the invention is a computationally efficient modeling framework for analysis and design of an electric motor employing an evaporative cooling system for thermal management including, comprising a digital computer system that includes a non-transitory computer readable storage medium that stores a computer program that embodies the model. The model includes a computational fluid dynamics/heat transfer (CFD/HT) model programmed on the computer system. The model also includes a lumped parameter thermal network (LPTN) model programmed on the computer system. The computational fluid dynamics/heat transfer (CFD/HT) model and the lumped parameter thermal network (LPTN) model generate an indication of expected performance of the evaporative cooling system during normal operation of the electric motor.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a schematic diagram of a permanent magnet synchronous motor employing an evaporative cooling system.

FIG. 2 is a schematic diagram of a section of a stator portion of an electric motor employing evaporative cooling liner jackets around the windings.

FIG. 3 is a schematic diagram showing a detail of coolant channels in a cooling liner jacket.

FIG. 4 is a schematic diagram showing a cooling liner jacket and a winding.

FIG. 5 is a block diagram of an electric motor system employing a cooling liner jacket system.

FIG. 6 is a schematic diagram showing one method of making a cooling liner jacket.

FIG. 7A-7D are schematic diagrams showing one method of making a microchannel or micropillar array used in a cooling liner jacket.

FIG. 7E-7F are photographs of a micropillar array and a mold for making a micropillar array.

FIG. 8 is a diagram of a computational domain of a 2-D EM simulation.

FIG. 9 is a schematic diagram of a 3-D LPTN model layout.

FIG. 10 is a schematic diagram of a resistance network of single slot, liner, and corresponding stator lamination

FIG. 11 is a diagram of a computational domain including BCs for CFD/HT simulation of JC.

FIG. 12 is a schematic of a resistance network of single slot, liner, and the corresponding stator lamination for EC.

FIG. 13 is a flow chart for a two-way coupling algorithm.

FIG. 14 is a schematic diagram of a computational system upon which modelling is run.

FIG. 15A is an expanded view of a motorette assembly testbed.

FIG. 15B is a schematic diagram showing the coolant flow path through the motorette assembly testbed.

FIG. 15C is a front view of a single slot in the motorette assembly testbed.

FIG. 16 is a schematic diagram showing a computational domain and BCs used in CFD/HT simulation.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. The present disclosure should in no way be limited to the exemplary implementations and techniques illustrated in the drawings and described below. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

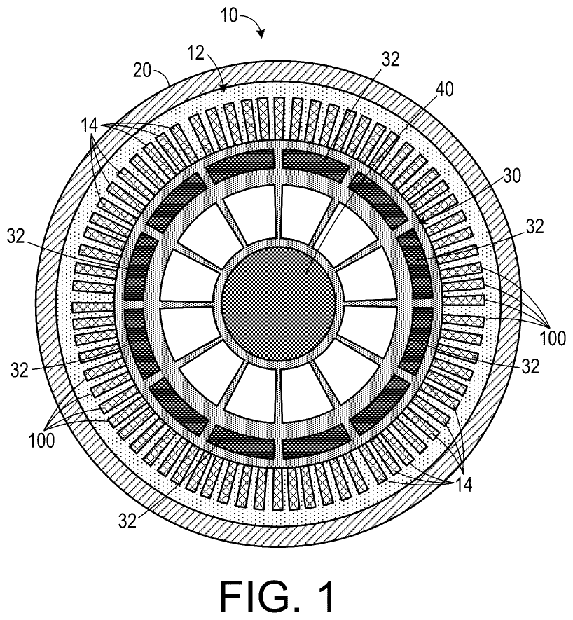

As shown in FIG. 1, one representative embodiment of a permanent magnet synchronous motor 10 employing an evaporative cooling (EC) system according to the present invention includes casing 10 that houses a stator 12. Embedded in the stator 12 is a plurality of electrical windings 14 that extend radially outwardly from an inner cylindrical surface of the stator 12 that defines a cylindrical passage in the stator 12. Each winding 14 has an inner end that abuts the inner cylindrical passage. Each electrical winding is at least partially enveloped in a winding liner 100 that is configured to deliver an evaporative coolant to the corresponding winding 14. The coolant flows between the winding and the liner so as to evaporate directly on an outer surface of the winding by absorbing heat therefrom. A cylindrical rotor 30 is disposed in the cylindrical passage defined by the stator 12. A plurality of permanent magnets 32 are embedded about the outer surface of the rotor 30. A shaft 40 is coaxial with the rotor 30 and attached thereto. When an electric current flows through the windings 14, an induced magnetic field interacts with the permanent magnets 32 to generate rotational force that is applied to the rotor 30 causing the shaft 40 to rotate. Also, application of a current to the windings 14 results in the generation of heat that is removed by the evaporative coolant flowing through the winding liner 100.

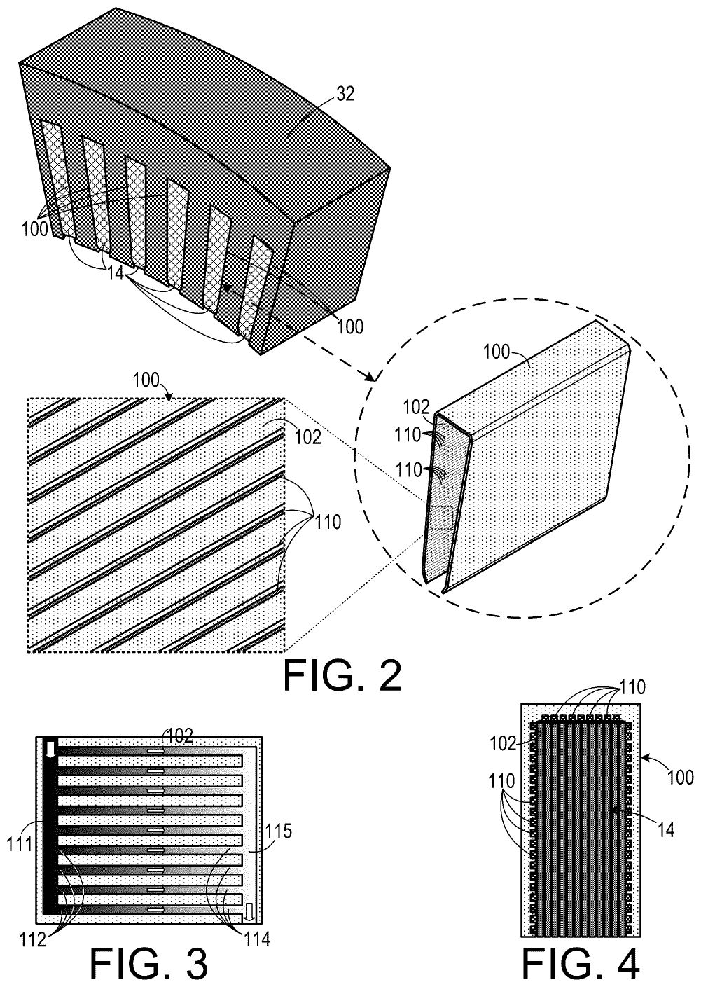

As shown in FIGS. 2, 3 and 4, the winding liner 100, which can include PDMS (or any other material suitable to provide sufficient electric breakdown strength, resistance to tearing and that do not degrade under conditions of temperature, vibration and electric field, depending on the specific embodiment and operating environment) and which is about 2.0 mm to 3.0 mm thick in one experimental embodiment, has an inner wall 102 that is placed against the winding 14. The wall 102 defines a plurality of channels 110, such as microchannels, into which a dielectric coolant (such as a perfluorinated liquid coolant, such as FC-84 with a saturation temperature of 80° C.) flows. The coolant has a liquid state 112 and evaporates into a gaseous state 114 as it absorbs heat from the winding 14. A delivery mechanism delivers the liquid coolant 112 to the channels 110 via an input manifold 111 and at least partially evaporated coolant 114 flows out of the channels 110 via an output manifold 115. The manifolds 111 and 115 may be in fluid communication with winding endcaps that interface with a heat exchanging system, as disclosed below. In one embodiment, the micro-channels 110 have dimensions that cause the coolant 112 to wick through a portion of the micro-channels 110 through capillary action. The channels 110 may be disposed horizontally, vertically or even diagonally relative to the windings 14, depending on the specific embodiment. The coolant flows between the active-winding and liner and evaporates directly from the outer surface of the active-winding by absorbing heat from the winding.

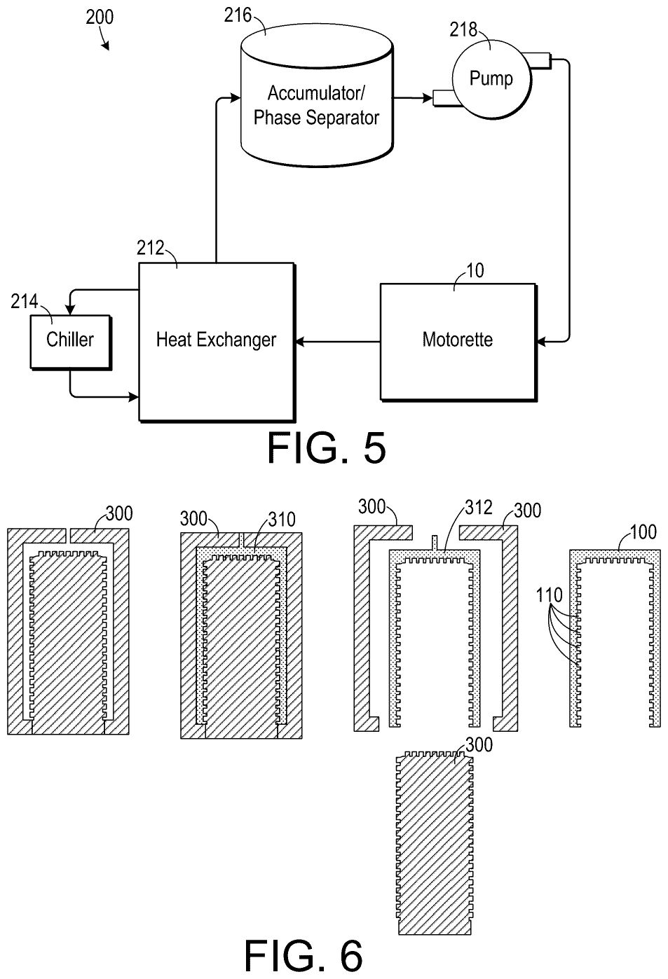

As shown in FIG. 5, one embodiment of a cooling system 200 that is used to cool a motor 10 includes a pump 218 that pumps liquid coolant into the motor 10 for delivery to the input manifold 110. At least partially evaporated coolant that has flowed into the output manifold 115 is delivered to a heat exchanger 212 that can employ a chiller 214 to condense the gaseous state coolant into a liquid state. The now mostly liquid coolant then passes into an accumulator/phase separator 216 that stores the coolant and that separates remaining gaseous state coolant from the liquid state coolant. The liquid state coolant is then moved by the pump 218 for another cooling cycle into winding liners 100 in the motor 10.

As shown in FIG. 6, in one method of making a winding liner 100, a mold 300 of the liner with the micro-channels is generated using known techniques, such as lithography. The liner material 310, such as PDMS, is injected into the mold 300 and the liner material 310 is cooled and/or cured. The mold 300 is removed, leaving a cast 312. Any sprues are removed from the cast 312 and any other finishing is done, leaving the liner 100 with the micro-channels 110. In certain embodiments, other methods of generating the winding liner 100 can include: nano-imprint lithography, diamond tooling creating via nickel electro form for stamping, embossing, laser drilling; chemical etching; employing wire EDM; and combinations thereof.

One experimental embodiment of the invention includes a design of an electric traction drive (electric motor) cooling system. This embodiment employs a method of windings-cooling that uses wick-assisted two-phase flow. The embodiment uses a dielectric coolant in direct contact with the heat source, which reduces several thermal resistances.

Dielectric coolant enters the motor, which is vacuumed sealed to form a closed system. The coolant is delivered to each of the slots of the stator through a combination of capillary pumping by wicking and mechanical pumping into individual slots. The coolant is in direct contact with the copper windings within each of the slots in the stator via the channels in the winding liners. It removes the heat dissipated by the copper windings and in the process evaporates, forming a mixture of liquid phase coolant and vapor phase coolant. The two-phases of the coolant is collected from the opposite side of the stator and is sent to the heat exchanger where it is liquefied and then re-enters the stator, repeating its cooling process. This design of the motor with two-phase cooling using embedded wicking in the channels improves the power density, as well as the efficiency of the motor.

The experimental embodiment includes a flow assisted thin film EC technique confined between the slot liner and active-winding of electric motor. EC in the interfacial region between the liner and active-winding can be utilized to extract heat directly from the winding without altering the winding configurations (i.e., the copper fill factor). Two-way coupled EM-computational fluid dynamics (CFD)/heat transfer (HT) simulations have demonstrated the effectiveness of the EC over conventional JC for a BMW i3 motor.

In high power density electric motors, heat losses are generated in the windings in the form of resistive heating. In JC, heat needs to flow from the winding to the external coolant via stator tooth, back iron, and finally the housing. Additionally, winding-liner, liner-tooth/back iron, and stator lamination-housing contact resistances increase the overall thermal resistance between the winding and the coolant. This long resistance chain can create hot spots inside the winding.

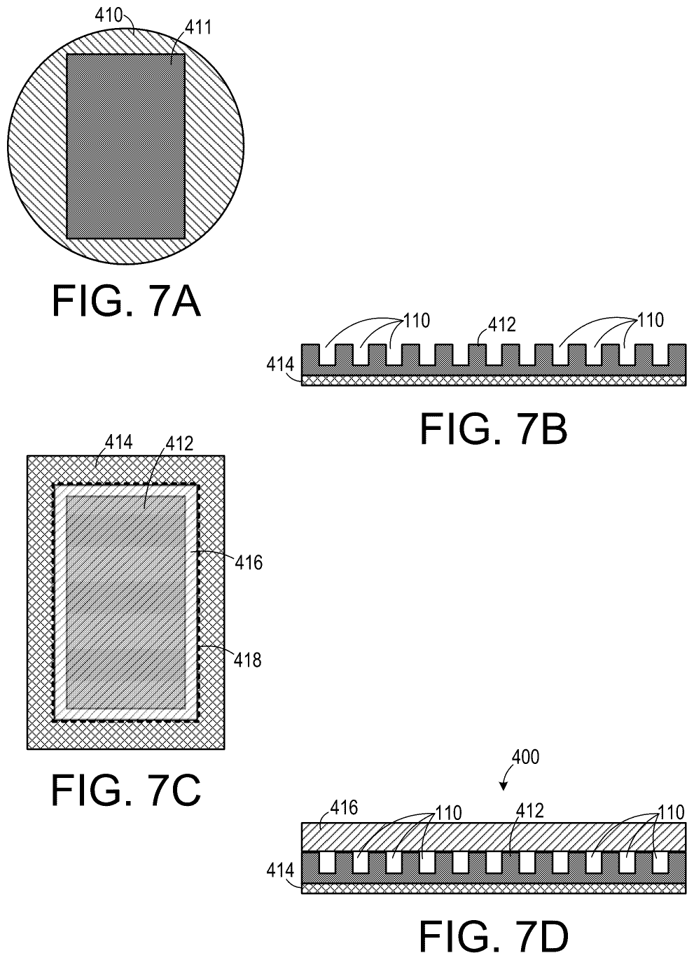

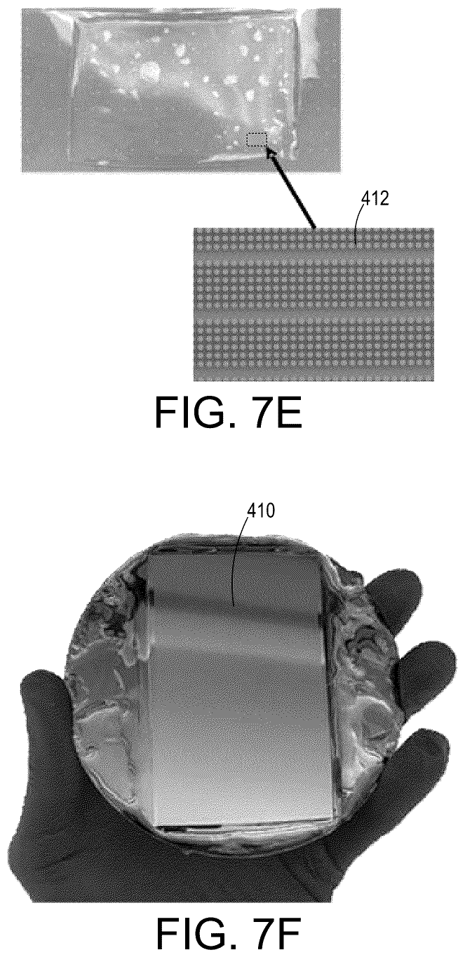

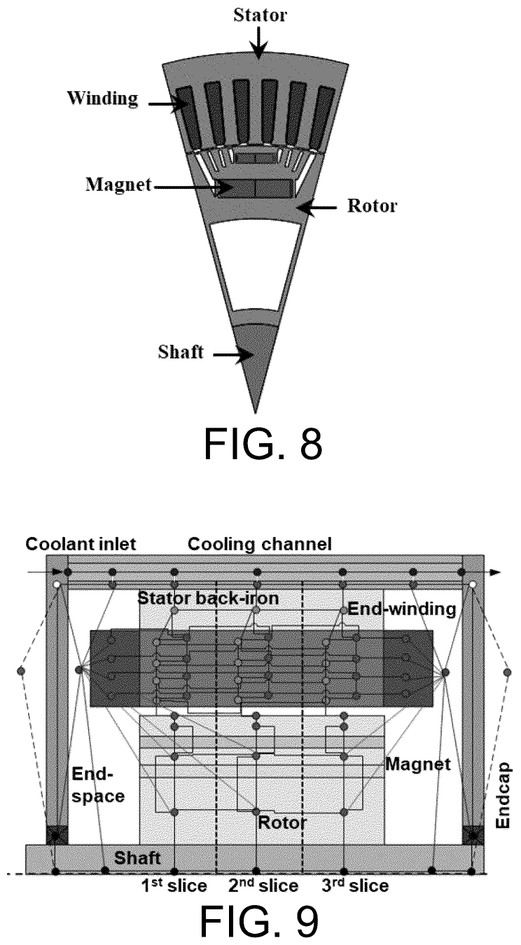

While one embodiment discussed above employs microchannels, the winding liner 100 can also employ an array of spaced apart micropillars. As shown in FIGS. 7A-7F, in one experimental method of making a micropillar array structure 400, a master mold 410 is generated using a deep reactive ion etch so as to include a negative copy of the wick structure 411. A silicone elastomer (such as PDMS) is poured onto the master mold 410, then degassed and cured in an oven. The resulting wick structure 412 is peeled away from the master mold 410 and adhered to a plastic substrate 414 using an adhesive 418. To protect the wick structure 412 from being fouled due to motor resin impregnation, a protective layer of material can be adhered to the surface 416. The polyamide protective film 412 prevents motor resin from entering the wick structure 412. A photograph of such a wick structure 412 is shown in FIG. 7E and a photograph of a master mold 410 is shown in FIG. 7F.

In one embodiment, the micro-wicking structure can be printed, stamped or embossed on the surface of flexible polymers such as polydimethylsiloxane (PDMS) and used as liner material in an electric motor. A wick enhanced PDMS liner can be inserted in the slots in such a way that wick micro-structures wrap the active windings. Hence, a channel structure can be created between the active-windings and the PDMS liners. Utilizing the capillary effect of the wick micro-structure, coolant in the form of a liquid thin film can be sucked and flowed axially through the channel structure between the active-winding and wick enhanced PDMS liner. Thin film evaporation confined between the liner and active-winding (i.e., evaporation directly outside of the active-winding) can significantly reduce the thermal resistance between the winding and the coolant by eliminating the winding-liner contact resistance, and hence can enhance the heat extraction from the winding. EC can also take advantage of high latent heat of vaporization, and heat transfer (contact) area between the winding and liner. Another advantage of the EC system is that it can be employed irrespective of different winding configurations. Compared to the JC and DWHX, latent heat driven EC can significantly reduce the pumping power requirement by lowering the coolant flow rates and utilizing capillary action of the wick.

To implement EC in a traction motor, a stator sleeve may be used to prevent any coolant leaking from the stator slots to the rotor. Additionally, some sort of coolant delivery arrangement, such as using a coolant reservoirs and end caps, may be used.

Two novel computational modeling techniques can be employed for modeling two-phase evaporative cooling (EC) of electric motors. The latent heat assisted EC technique can be employed for the thermal management of next-generation electric machines, such as motors. However, the high computational cost of the existing modeling techniques, especially for multi-phase cooling, often limits the deployment of the numerical tools in the early stage of the cooling system parametric trade-off studies in support of design. In order to simulate EC with a minimal computational cost and without compromising with accuracy, a numerically affordable computational fluid dynamics/heat transfer (CFD/HT) modeling framework introduces a heat absorption term in the energy equation. To further reduce the computational cost, a lumped parameter thermal network (LPTN) modeling framework is used to model EC. Since electromagnetic (EM) and thermal performance of electric motor strongly depend on each other, a two-way coupled EM; CFD/HT and EM-LPTN models can be used to assess the electrothermal performance of the EC under steady state and transient conditions. Such EM-CFD/HT and EM-LPTN models have been utilized experimentally to characterize and compare the performance of EC with the state-of-the-art (SOA) jacket cooling (JC). Furthermore, the applicability of the modeling techniques has been validated over a dynamic drive cycle.

The subject of this invention is a computationally efficient modeling framework for analysis and design of electric motors considering evaporative cooling (EC) for thermal management. The framework utilizes combination of computational fluid dynamics/heat transfer (CFD/HT) and lumped parameter thermal network (LPTN) models. The effect of EC is considered as a volumetric heat absorption term, which depends on the evaporative heat transfer coefficient, contact surface area between the solid and fluid domain, and the temperature difference between the solid-liquid contact surface and the fluid domain. Evaporative heat transfer coefficient can be obtained from the experiments, and the solid-fluid interfacial surface area can be calculated by knowing the geometrical configuration of the system. So, by knowing the evaporative heat transfer coefficient, contact surface area between the solid and fluid domain, and the fluid saturation temperature, EC can be modeled as volumetric heat absorption by adding an appropriate term into the energy equation in the CFD/HT model, which can be iteratively solved to obtain the temperature distribution.

In the LPTN model, constant fluid saturation temperature can be represented as constant temperature node and EC can be represented as convective resistance connected between the solid-fluid interfacial node and fluid saturation temperature node. Convective resistance can be calculated by knowing evaporative heat transfer coefficient and solid-fluid domain interfacial surface area. As mentioned earlier, the evaporative heat transfer coefficient can be obtained from the experiments and contact surface area between the solid-fluid domains can be calculated by knowing the structural layout of system.

As electro-magnetic (EM) and thermal performance of the electric motor are strongly dependent on each other, a two-way coupled EM; CFD/HT and EM-LPTN models have been developed to assess the electro-thermal performance of the EC. In the first iteration of the two-way iteratively coupled algorithm, electro-magnetic losses in motor winding, stator, rotor, and magnets are calculated using pre-defined temperatures. Afterwards, the calculated losses are transferred to the thermal model (LPTN/CFD/HT) to compute motor temperature. The calculated motor temperature from the thermal model is fed back to the electro-magnetic model. Subsequently, motor loss components have been recalculated using the updated temperatures. Since electro-magnetic and thermal models are linked via the motor temperature, iterations have been carried out until the maximum temperature difference between two adjacent steps became less than a predetermined temperature difference.

Motor Topology

In one experimental embodiment, in order to demonstrate the effectiveness of the proposed slot-liner confined EC, a 72-slot 12-pole 125-kW three-phase jacket-cooled BMW i3 motor was chosen as base configuration (of the type shown in FIG. 1). Two layers of the magnet have been buried in rotor lamination, sliced into six axial segments, and stacked in a skewed arrangement to reduce the torque ripple, cogging torque, and magnet loss. Shrink fit spiral cooling channels have been used to extract heat from the outer surface of the stator lamination. The detailed specification of the BMW i3 motor is listed in the following table:

| Parameters (unit) | Value |
|---|---|
| Peak/rated torque (N · m) | 250/150 |
| Peak/rated power (kW) | 125/75 |
| Maximum/rated speed (rpm) | 11,400/4,800 |
| DC-link voltage (V) | 352 |
| Geometric Specifications | |
| Stator OD (mm) | 240.9 |
| Stator ID (mm) | 179.6 |
| Air gap (mm) | 0.5 |
| Active length (mm) | 130 |
| Total length (mm) | 222 |
| Stator/rotor lamination | M250-35A |
| Magnet | N42UH |
| Impregnation material | Varnish |
| Liner material | CeQUIN I |
| Liner thickness (mm) | 0.3 |
| Liner conductivity (W/m · K) | 0.195 |
| Weight (kg) | 39.39 |
| Volume (L) | 11.79 |
| Winding configuration | |
| Number of turns per coil | 9 |
| Number of strands in hand | 12 |
| Parallel path | 6 |
| Total number of wire | 108 |
| Copper slot fill factor | 0.3332 |
| Motor cooling | |
| Housing material | Aluminum (Al) |
| Housing diameter (mm) | 260 |
| Coolant | ethylene-glycol 50/50 |

For EC, the same motor topology of BMW i3 was used, with the exception that the spiral cooling channel was removed, and CeQUIN I liner was replaced with a 0.3-mm-thick PDMS liner (with thermal conductivity of 0.15 W/m·K), modified with a wick structure.

Since, in the case of EC, the coolant will be in direct contact with the winding, it needs to be dielectric to ensure the electrical integrity of the winding. After considering dielectric strength, boiling temperature, vapor pressure, and thermal conductivity requirement, dielectric coolant FC-84 with a saturation temperature of 80° C. was chosen for the EC simulation. Since, in the case of EC, coolant will flow through the liner, a thinner (taken as 2 mm in this example) Al casing can be used to protect the motor core from the ambient. For the same winding configuration, the total weight and volume of the evaporative cooled BMW i3 motor was estimated as 36.49 kg and 10.45 L, respectively, which is 7.4% and 11.4% less compared to the existing jacket-cooled BMW i3 motor. For the same output power as the BMW i3 motor, improved thermal performance of EC will allow further shrinkage of the motor size by permitting higher current density.

Numerical Modeling

A. Electromagnetic Simulation

A finite element model was built in Motor-CAD to assess the EM performance of both cooling configurations. In order to reduce the computational cost, a single rotor pole and the corresponding stator configuration have been considered as the computational domain for the EM simulation, as shown in FIG. 7. Al housing and cooling channels were not included in the simulation domain.

The EM torque, Tre, was calculated as follows:

$${Tr}_{e} = \frac{m}{2} p ( {λ}_{d} {I}_{q} - {λ}_{q} {I}_{d} )$$

where m is the number phase, P is the number of pole pairs, λd and λq are d- and q-axis flux linkages, and Id and Iq are d- and q-axis currents, respectively. λd depends on the residual magnetic flux density, Bres, which was calculated using the following equation:

$${B}_{res} = {B}_{res , ref ( 20 )} ( 1 + \frac{α ( {T}_{m} - {T}_{ref \cdot temp ( 20 )}}{100} )$$

where Tm is the magnet temperature, B_{res,ref(20)}=1.31 T at a reference temperature of 20° C., and the temperature coefficient (α) is −0.12/° C.

The shaft torque (Trₛ) was calculated as follows:

TRₛ=Trₑ−[(P_{core}+P_{mag})/ω]

where ω is the shaft speed, and Pcore and Pm are core and magnet losses, respectively.

P_{Core} was calculated using the modified Steinmetz iron loss model:

P_{core}(W/kg)=Kₕf·B^{γ+∂B}+2π²K_{eddy} f²B²

where Kₕ, γ, ∂, and K_{eddy} have been determined using curve fitting techniques in Motor-CAD.

P_{mag} was calculated by knowing magnet eddy current from diffusion equation.

The copper loss/dc loss in the active and end-winding and the ac loss in the active-winding have been calculated by using the following equations:

$${P}_{dc} = 3 {I}^{2} {R}_{e} [ 1 + {a}_{T} ( {T}_{ω} - {T}_{a} ) ]$$

$${P}_{ac} = \frac{π {{D}^{2} ( ω B )}^{2}}{128 {R}_{a} [ 1 + {a}_{T} ( {T}_{ω} - {T}_{a} ) ]}$$

where Ra is the electrical resistivity at ambient temperature (Tₐ) of 20° C., TW is the copper wire temperature, and D is the wire diameter.

The overall efficiency was calculated as follows:

$$η = \frac{{P}_{out}}{{P}_{out} + {P}_{dc} + {P}_{ac} + {P}_{core} + {P}_{mag}}$$

where Pₒᵤₜ=(Trₛ ω) is the output power.

Moreover, mechanical and windage losses have been neglected in the EM simulations.

B. Heat Transfer Modeling for JC

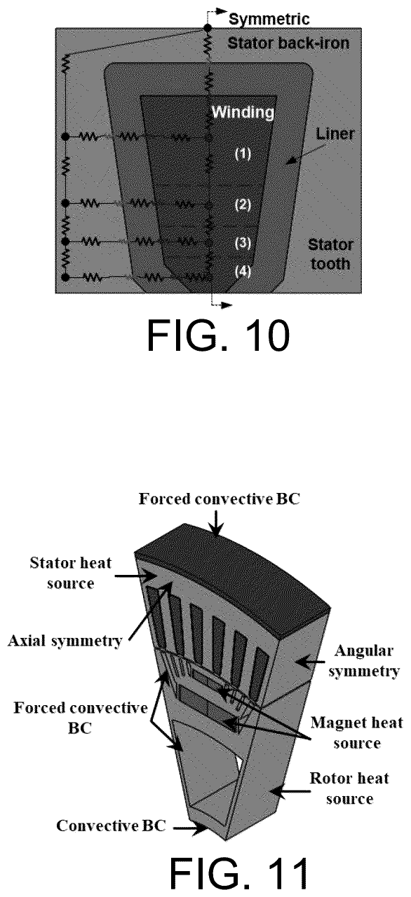

1) Lumped Parameter Thermal Network, Model: To accurately and efficiently compute HT in radial and axial directions, a 3-D LPTN model, including the JC circuit, was developed based on the jacket-cooled BMW i3 motor geometry in the Motor-CAD environment. FIG. 9 presents the adopted axial thermal network layout where black, blue, and white lines indicate conduction, natural convection to the end-space, and forced convection in outer jacket, respectively. In addition, in order to assess the axial HT, the motor was split into three longitudinal slices. The active and end-winding regions use the cuboidal element approach where the winding compounds are modeled as a single component with anisotropic thermal conductivity. The active and end-winding regions use four radially distributed cuboidal elements, and the stator tooth region is also modeled accordingly (see FIGS. 9 and 10).

FIG. 10 shows the radially discretized winding region along with four cuboids, where blue and red resistances indicate winding-liner and liner-lamination contact resistances, respectively. It is worth underlining that the skewed cuboidal model was utilized to accurately capture ac loss, especially in the slot opening region, and contact resistances are calculated using individual cuboid dimensions.

The high rotational speed of the rotor creates a regular air vortex pattern inside the air gap and increases the HT between the stator and the rotor. HIT across the air gap was calculated based on correlations is modeled as follows:

$$Ta = \frac{{I}_{air gap} ω r}{{ϑ ( {I}_{air gap} / {r}_{r} )}^{0.5}}$$

$$Nu = 2 ( Ta < 41 )$$

$$Nu = 0.212 {Ta}^{0.63} {Pr}^{0.27} ( 41 \leq Ta \leq 100 )$$

$$Nu = 0.386 {Ta}^{0.5} {Pr}^{0.27} ( Ta > 100 )$$

$$h = \frac{Nu {k}_{air}}{2 {l}_{air gap}}$$

where Ta is the Taylor number, Iair gap is the air gap length, ω is the rotational speed, rr is the rotor radius, ∂ is the kinematic viscosity, Pr is the Prandtl number, kair is the air gap thermal conductivity, Nu is the Nusselt number, and h is the HT coefficient. Air properties have been calculated as a function of temperature.

Considering fully developed turbulent flow, forced convective FIT coefficient was calculated using the Gnielinski correlations, as follows:

$$υ = Q / A ; Re = \frac{υ {D}_{b}}{ϑ}$$

$$f = {( 0.79 ln Re - 1.64 )}^{- 2}$$

$$Nu = \frac{( f / 8 ) ( Re - 1000 ) Pr}{[ 1 + \{ 12.7 {( f / 8 )}^{0.5} ( {Pr}^{2 / 3} - 1 ) \} ]}$$

$$h = \frac{Nu {k}_{l}}{{D}_{h}}$$

where Q is the flow rate, v is the velocity, A is the cross-sectional area, Dh is the hydraulic diameter, Re is Reynold's number, f is the friction factor, and kl is the coolant thermal conductivity.

HTs from the rotor, magnet, and the end-winding to the end-spaces have been calculated. Heat will be transferred from the rotor slots to the end-spaces via forced convection. Considering the high rotational speed and the complicated rotor duct geometry, a constant forced convective HT coefficient of 150 W/m²·K was chosen. Brown lines in FIG. 9 indicate UT from the rotor slots to the end-spaces. In addition, natural convection HTs from the housing to the ambient and all radiation HT have been neglected in the LPTN model. Calculated power losses from the EM simulation have been applied as heat sources. For transient simulations, component's thermal capacities have been added in the LPTN model.

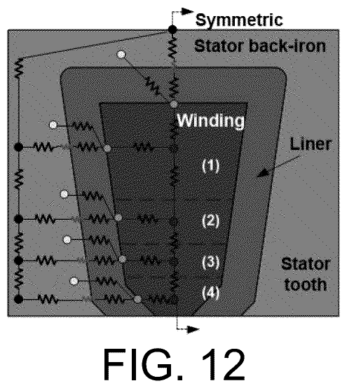

2) Computational Fluid Dynamics/Heat Transfer Model: FIG. 11 illustrates the computational domain for the CFD/HT simulations. In order to reduce the computational cost, only 1/12th of the cross section, consisting of one rotor pole and the corresponding stator core, six windings and liners, air gap, and housing, was chosen as a computational domain by realizing angular symmetry. In addition, ⅙th axial section of the total active length was modeled, assuming negligible temperature change along the axial direction, i.e., axial symmetry.

Assuming negligible radiation HT, uniform distribution of heat sources, isotropic thermal conductivity (k) for magnet, liner, and housing materials, and anisotropic k for winding and lamination materials, the 3-D heat conduction equation was solved the following differential equation:

$$\frac{1}{r} \frac{\partial }{\partial r} ( {k}_{r} r \frac{\partial T}{\partial r} ) + \frac{1}{{r}^{2}} \frac{\partial }{\partial θ} ( {k}_{θ} r \frac{\partial T}{\partial θ} ) + \frac{\partial }{\partial z} ( {k}_{z} \frac{\partial T}{\partial z} ) + {q}^{m} = ρ {C}_{P} \frac{\partial T}{\partial t}$$

where [symbol] is the volumetric heat generation rate calculated from the EM model, ρ is the density, and Cp is the specific heat. In the case of steady-state simulation, the right-hand side of this equation was neglected.

C was simulated as a forced convection boundary condition (BC) on the housing surface as follows:

$$- k \frac{\partial T}{\partial r} = h ( {T}_{sur} - {T}_{f} )$$

where h is calculated from the Gnielinski correlations, Tₛᵤᵣ is the average surface temperature, and T_{f} is the coolant temperature. Since the cooling channel has not been considered in the CFD/HT model, T_{f} was imported from the LPTN model. Similarly, HT from rotor ducts was modeled as convection BC with an HT coefficient of 150 W/m²·K (see FIG. 11). In addition, a convective BC is also applied on the rotor bottom face to model HIT via the shaft.

After a sequential mesh independent testing, 1.9 million meshes have been used for the CFD/HT simulations. The 3-D CFD/HT simulations were performed in finite volume-based software ANSYS Fluent. The energy equation was discretized using the second-order upwind scheme, and the solution was assumed to be converged when the residuals are reduced below 10⁻⁹.

C. Modeling of Evaporative Heat Transfer

1) LPTN Model: In the case of EC, coolant flows between the active-winding and liner, and evaporates directly on the outer surface of the active-winding by absorbing heat from the winding. Therefore, in the LPTN model, the winding-liner contact resistance was neglected, as illustrated in FIG. 12. (In which Red resistance indicates liner-lamination contact resistance, and yellow nodes are set at a constant saturation temperature of 80° C.) Moreover, in the case of thin-film evaporation, the coolant temperature can be assumed as constant at saturation temperature. To simplify the evaporation model, winding-liner interface nodes (orange nodes in FIG. 12) have been connected with constant saturation temperature nodes (yellow nodes) via a convective resistance, R_{c,eva}, which is calculated as follows:

$${R}_{c , eva} = \frac{1}{{h}_{eva} {A}_{int .}}$$

where Aᵢₙₜ is the cuboidal interface area between the winding and liner, and was calculated for individual cuboids and hₑᵥₐ is the evaporative HT coefficient, which was assumed to be known. Since, in this experimental embodiment, FC-84 was chosen as a coolant with a saturation temperature of 80° C., constant temperature nodes (yellow nodes in FIG. 12) are set at that temperature. Moreover, the external JC circuit was removed from the 3-D LPTN model.

2) CFD/HT Model: In the CFD/HT model, an evaporative heat absorption term as a negative heat source in the liner was introduced in the energy equation:

Qₑᵥₐ=−hₑᵥₐAᵢₙₜ(T_{wind,o}−Tₛₐₜ)

where Qₑᵥₐ is the overall heat absorption via evaporation, Aᵢₙₜ is the interfacial area of the winding and the liner, and T_{wind,o} is the average winding outer surface temperature. Since Qₑᵥa depends on the instantaneous winding temperature, the negative heat source term in the CFD/HT simulation was implemented via a user-defined function (UDF) in ANSYS Fluent.

D. Electromagnetic and HT Simulation Coupling

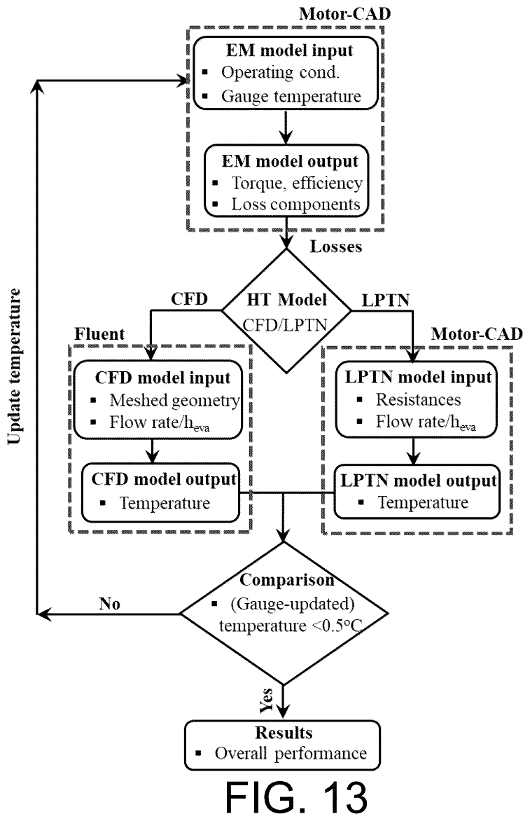

EM and thermal performances of the electric motor are strongly dependent on each other via winding and magnet temperatures, and power losses. Therefore, EM and thermal simulations have been performed in a two-way coupled environment. The detailed flowchart of the coupled EM and HT modeling is presented in FIG. 13. Coupled EM-CFD/HT and EM-LPTN simulations have been abbreviated as only CFD and LPTN, respectively.

E. Contact Resistance The thermal contact resistance (R_{t,c}) between rotor lamination-magnet, winding-slot liner, slot liner-stator lamination, and stator lamination-housing (for JC) was shown to have a significant effect on the motor temperature distribution. The following table summarizes equivalent air gap cavity thicknesses (l_{g}) and the corresponding thermal contact conductances:

| | Equivalent air gap | Conductance¹ |
|---|---|---|
| Interface | thickness (mm) | (W/m² · K) |
| Rotor lamination- | 0.005 | 6,342 |
| magnet | | |
| Stator lamination- | 0.0057 | 5,563 |
| housing | | |
| Winding-liner | 0.045 | 705 |
| Liner-stator | 0.015 | 2,114 |
| lamination | | |

¹For conductance calculation, air thermal conductivity has been assumed as constant 0.03171 W/m² · K.

It has been calculated the equivalent winding-stator lamination lg is 0.06 mm for CeQUIN I liner material (which is typically used in BMW i3 motor). In addition, NREL reported that winding-liner R_{t,c} is about three times higher than liner-stator R_{t,c} for the Nissan Leaf motor. By combining theses and assuming similar winding-liner Rt,c for BMW i3 as the Nissan Leaf motor, lg between winding-liner and liner-lamination, and the corresponding conductance's have been calculated, as shown in the table above.

The same R_{t,c} has also been used for EC, except winding-liner R_{t,c}. As explained above, in the case of EC, the coolant is in direct contact with the winding; therefore, winding-liner R_{t,c} was neglected. In the LPTN model, all R_{t,c} 's have been inputted directly, and in the CFD model, equivalent l_{g} was used to model R_{t,c}.

F. Thermophysical Properties of Winding and Lamination

Winding is a heterogeneous mixture of copper wire, wire insulation, and impregnation materials. In order to model it as a single material, equivalent radial/circumferential thermal conductivity (kᵣ/k_{θ}) was calculated from the relative volume of the copper wire (slot fill factor), impregnation [considering goodness factor (GF)], and insulation materials. Winding axial thermal conductivity (k_{z}), equivalent density (ρ), and specific heat (Cₚ) were calculated using the parallel model.

Similarly, equivalent axial thermal conductivity (k_{z}), density (ρ), and specific heat (Cₚ) of the lamination material, considering a packing factor of 0.97, were also calculated using the parallel model. The table below summarizes the calculated thermophysical properties of the winding and lamination:

| | Winding | | | Lamination | |
|---|---|---|---|---|---|
| Component | | Insu- | Impreg- | M250- | Inter- |
| Material | Cu | lation | nation | 35A | lamination |
| k (W/m · K) | 401 | 0.21 | 0.25 | 30 | 0.027 |
| ρ (kg/m³) | 8933 | 1400 | 1400 | 7650 | 1127 |
| Cₚ (J/kg · K) | 385 | 1000 | 1700 | 460 | 1007 |

| | | |
|---|---|---|
| Fill/packing | 0.3332 | 0.97 |
| factor | | |
| Equivalent | 0.50/0.50/ | 29.1/29.1/ |
| kᵣ/k_{θ}/k_{z} | 166 | 1.13 |
| Equivalent ρ | 4366.98 | 7420.53 |
| Equivalent Cₚ | 564.11 | 460 |

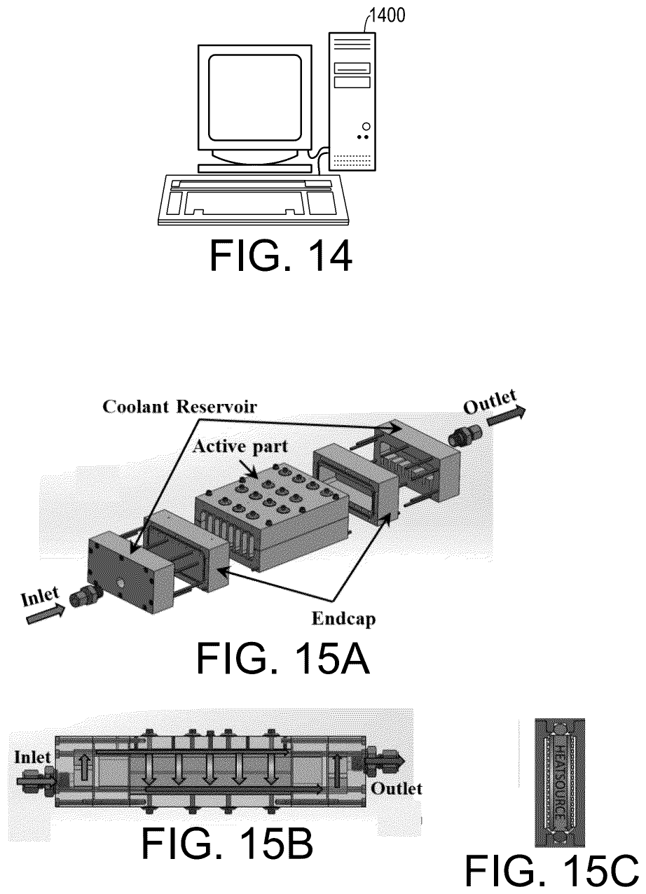

In one embodiment, as shown in FIG. 14, simulation was performed using a conventional digital computer 1400 that includes a non-transitory computer readable storage medium upon which as program embodying the above-described simulation algorithm is stored.

### Experimental Validation

A. Motorette Test Setup

In order to validate the simulation results a 2-kW de motorette testbed with eight slots was designed and fabricated. Although the stator of a real motor is made from compressed sheets of laminated steels, but to simplify the experiment setup, an aluminum bar was used to fabricate the motorette testbed. The major components of design include three pails: coolant reservoir, end-cap to cover end-windings, and the active part with the slots and wick-enhanced PDMS liner, as shown in FIG. 15. It is worth noting that the motorette slot size is identical to the BMW i3 motor winding slot, and motorette slots were hand-wound with 108-turn AWG 21 enameled magnet copper wire. (A schematic diagram of the flow loop with the motorette in the two-phase loop is shown in FIG. 5.)

A schematic of the coolant flow through the motorette testbed is shown in FIGS. 15A-15C. From the upstream reservoir, the coolant is pumped into the slot liner through the top hole, as shown in FIG. 15C. Afterward, the coolant flows downward, assisted by the capillary action of the wick while evaporating. Finally, the mixture of liquid and vapor (two-phase flow) exits in the bottom hole of the slot and is condensed back to liquid outside of the testbed through the outlet. In the experimental embodiment, the winding was powered by Agilent Technologies N8931A dc power supply. Six T-type sheathed probe thermocouples were axially placed inside a single slot to accurately measure the winding temperature profile.

The cooling loop included a liquid pump, a heat exchanger, accumulator/phase separator (reservoir), flowmeter, data acquisition system, and a dc power source. The flow rate, inlet and outlet temperature, and temperature within the testbed were recorded using the Agilent 3970A data acquisition system.

The motorette testbed was prepared with an intention to test the EC performance inside impregnated slots. However, due to some technical issues of the impregnation curing oven, impregnation material could not be applied in the motorette slot. Therefore, EC testing was performed in the non-impregnated motorette setup. Due to the absence of impregnation material, coolant was not only confined in between the liner and winding, and some coolant may enter inside the slots. In addition, dielectric coolant Novec-7200 with a saturation temperature of 76° C. was used for the motorette testing.

B. CFD/HT Model

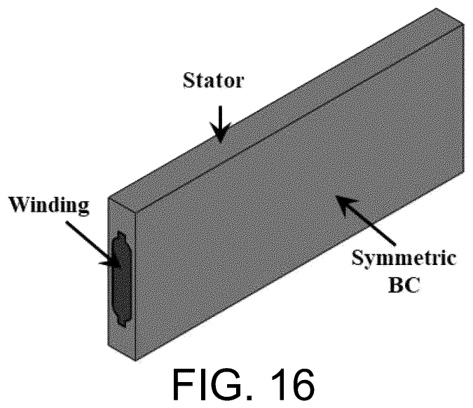

To mimic the motorette testing, a modified CFD/HT model was developed for the thermal simulation, as shown in FIG. 16. A single slot was used for the CFD/HT modeling using symmetric BCs, and only active-winding was considered.

C. Comparison Between Experimental and Numerical Results

The following table compares the measured and CFD/HT predicted steady-state average active-winding temperature for different input powers and coolant flow rates:

| | | Average active-winding | |
|---|---|---|---|
| Power | Flow rate | temperature (° C.) | |
| (W) | (mL/min) | Measured | CFD/HT |
| 702.9 | 330 | 113.80 | 113.80 |
| 1106 | 440 | 126.82 | 126.82 |
| 1500.7 | 520 | 137.40 | 137.39 |
| 1606.3 | 520 | 149.10 | 149.10 |
| 1702.9 | 640 | 135.20 | 135.19 |
| 2001.6 | 640 | 145.20 | 145.19 |

From the table, it can be seen that the CFD/HT model can accurately predict the measured active-winding temperature with a deviation of less than 0.01° C.

The measured active-winding temperature agreed well with the predicted temperatures extracted from the CFD/HT model irrespective of the input power. For both input powers, the maximum difference between the measured and predicted temperature was less than 3.4° C.

Evaporative cooling can enhance the heat extraction from the winding by reducing the thermal resistance between the winding and coolant. Slot-liner confined EC does not alter the winding copper fill factor, i.e., EM performance, and is applicable in all kinds of electric motor applications, irrespective of the winding configuration. Taking an existing jacket-cooled BMW i3 motor as a base case, two-way coupled EM-CFD/HT and EM-LPTN models have been developed to assess the effectiveness of EC over the JC for a wide range of current densities. Dielectric coolant FC-84 with a saturation temperature of 80° C. was considered for EC. Numerical results show that, within the insulation thermal limit, and at an evaporative HT coefficient of 5000 W/m2·K, EC increases the rms current density by ˜78.7% (26 A/mm2 continuous) compared to the JC and also maintains high electrothermal efficiency over the JC at any particular current density. Moreover, in the case of EC, the steady-state rms current density can be increased up to 30 A/mm², which is about 106.2% higher compared to JC, by using high thermal conductive epoxy impregnation material. Under transient conditions, EC with epoxy impregnation (ECEP) enables a 30-s peak rms current density of 40.8 A/mm² within the thermal limit of class H insulation. EC and ECEP also exhibit superior thermal performance compared to the JC over a dynamic duty cycle. A 2-kW motorette testbed was designed and fabricated to demonstrate the applicability of the flow-assisted EC and validate the developed CFD/HT model under steady-state and transient conditions. Superior electrothermal performance and universal applicability of EC make it a superior cooling technology for the next generation of high power density electric motors.

Although specific advantages have been enumerated above, various embodiments may include some, none, or all of the enumerated advantages. Other technical advantages may become readily apparent to one of ordinary skill in the art after review of the following figures and description. It is understood that, although exemplary embodiments are illustrated in the figures and described below, the principles of the present disclosure may be implemented using any number of techniques, whether currently known or not. Modifications, additions, or omissions may be made to the systems, apparatuses, and methods described herein without departing from the scope of the invention. The components of the systems and apparatuses may be integrated or separated. The operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. It is intended that the claims and claim elements recited below do not invoke 35 U.S.C. § 112(f) unless the words “means for” or “step for” are explicitly used in the particular claim. The above-described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A method of generating a design of a cooling system for an electric motor according to a cooling system specification, comprising the steps of:
(a) generating a design for an evaporative cooling jacket for the electric motor;
(b) modelling the design by executing the following steps employing a computer program stored on a digital computer including a non-transitory computer readable storage medium:
(i) generating an electromagnetic model of the design for simulating electromagnetic parameters in the electric motor and the cooling system;
(ii) generating a motor heat transfer model of the design for determining heat transfer in the electric motor;
(iii) generating an evaporative heat transfer model for simulating heat transfer in the cooling system due to evaporative cooling;
(iv) generating a contact resistance model of the design to determine contact resistance between a rotor lamination-magnet, a winding-slot liner, a slot liner-stator lamination, and a stator lamination-housing;
(v) generating a thermophysical properties model of the design that incorporates equivalent axial thermal conductivity (kz),
density (ρ), and specific heat (Cp) of lamination material employed in the design;
(c) comparing results of the electromagnetic model, the motor heat transfer model, the evaporative heat transfer model, the contact resistance model and the thermophysical properties model to the cooling system specification; and
(d) modifying the design of the cooling system when the results differ from the specification.

2. The method of claim 1, further comprising the step of coupling the electromagnetic model and motor heat transfer model to generate a two-way coupled model of the design.

3. The method of claim 1, further comprising the steps of:
(a) building a motorette test bed according to selected characteristics of the design;
(b) acquiring data regarding thermophysical properties of the motorette test bed while operating the motorette test bed; and
(c) comparing results of the electromagnetic model, the motor heat transfer model, the evaporative heat transfer model, the contact resistance model and the thermophysical properties model to the data acquired while operating the motorette test bed.

4. A method for analyzing and designing electric motors employing evaporative cooling (EC) for thermal management, comprising the steps of:
(a) determining fluid dynamics/heat transfer (CFD/HT) with a CFD/HT model; and
(b) determining a lumped parameter thermal network (LPTN) with an LPTN model.

5. The method of claim 4, wherein the step of determining fluid dynamics/heat transfer (CFD/HT) comprises the steps of:
(a) calculating at least one heat absorption term in an energy equation; and
(b) modeling EC with a lumped parameter thermal network (LPTN) modeling framework.

6. The method of claim 5, wherein the step of modeling EC with a lumped parameter thermal network (LPTN) modeling framework comprises the steps of:
(a) assessing the electrothermal performance of the EC under steady state and transient conditions with an electromagnetic (EM)-LPTN model;
(b) applying an EM-CFD/HT model; and
(c) utilizing the EM-CFD/HT model and the EM-LPTN model to characterize and compare the performance of EC with the state-of-the-art (SOA) jacket cooling (JC).

7. The method of claim 4, including each and every novel feature or combination of features disclosed herein.

8. A computationally efficient modeling framework for analysis and design of an electric motor employing an evaporative cooling system for thermal management including, comprising a digital computer system that includes a non-transitory computer readable storage medium that stores a computer program that embodies the following model:
(a) a computational fluid dynamics/heat transfer (CFD/HT) model programmed on the computer system; and
(b) a lumped parameter thermal network (LPTN) model programmed on the computer system,
wherein the computational fluid dynamics/heat transfer (CFD/HT) model and the lumped parameter thermal network (LPTN) model generate an indication of expected performance of the evaporative cooling system during normal operation of the electric motor.

9. The computationally efficient modeling framework of claim 8, wherein the computational fluid dynamics/heat transfer (CFD/HT) model comprises:
(a) a heat absorption term in the energy equation; and
(b) a lumped parameter thermal network (LPTN) modeling framework that models EC.

10. The computationally efficient modeling framework of claim 9, wherein the lumped parameter thermal network (LPTN) modeling framework comprises:
(a) an electromagnetic (EM)-LPTN model that assesses the electrothermal performance of the EC under steady state and transient conditions; and
(b) an EM-CFD/HT model,
wherein the EM-CFD/HT model and the EM-LPTN model are utilized to characterize and compare the performance of EC with the state-of-the-art (SOA) jacket cooling (JC).
